(19) United States
(12) Patent Application Publication
(10) Pub. No.: US 2013/0010915 A1
(43) Pub. Date: Jan. 10, 2013

(54) REACTOR FUEL ELEMENTS AND RELATED METHODS

(75) Inventors: John E. Garnier, Idaho Falls, ID (US); George W. Griffith, Idaho Falls, ID (US); Michael V. Glazoff, Idaho Falls, ID (US); Sergey Rashkeev, Idaho Falls, ID (US)

(73) Assignee: BATTELLE ENERGY ALLIANCE, LLC, Idaho Falls, ID (US)

(21) Appl. No.: 13/178,884

(22) Filed: Jul. 8, 2011

(51) Int. Cl. G21C 3/00

(52) U.S. Cl. 376/417

(57) ABSTRACT

Fuel elements for use in reactors include a cladding tube having a longitudinal axis and fuel disposed therein. At least one channel is formed in at least one of the fuel and the cladding tube and extends in a direction along the longitudinal axis of the cladding tube. The fuel element further includes a plenum having at least one getter material disposed therein. Methods of segregating gases in fuel elements may include forming a temperature differential in the fuel element, enabling at least one gas to travel into at least one channel formed in the fuel element, and retaining a portion of the at least one gas with at least one getter material. Methods of segregating gases in fuel elements also may include enabling at least one gas to travel through at least one channel of a plurality of channels formed in the fuel element.

### STATEMENT REGARDING FEDERALLY SPONSORED RESEARCH OR DEVELOPMENT

This invention was made with government support under Contract Number DE-AC07-051D14517 awarded by the United States Department of Energy. The government has certain rights in the invention.

### TECHNICAL FIELD

Embodiments of the present disclosure relate generally to fuel elements for use in nuclear reactors. More particularly, embodiments of the present disclosure relate to fuel elements including at least one channel formed therein and one or more getter materials to facilitate the separation and containment of gases within the fuel element, and methods related thereto.

### BACKGROUND

Nuclear reactor fuel designs, such as pressurized water reactor and boiling water reactor fuel designs, impose significantly increased demands nuclear fuel cladding tubes. Such components are conventionally fabricated from the zirconium-based metal alloys, such as zircaloy-2 and zircaloy-4. Increased demands on such components are in the form of longer required residence times, thinner structural members, and increased power output per area, which cause corrosion. Nuclear fuel cladding tubes are required to be resistant to radiation damage, such as dimensional change and metal embrittlement. Zirconium alloys are currently used as the primary cladding material for nuclear fuel in nuclear power plants because of their low capture cross-section for thermal neutrons and good mechanical and corrosion resistance properties, high thermal conductivity and high melting point.

Nonetheless, fuel cladding tubes are still susceptible to stress corrosion cracking during operation due to fission products and the radiation-induced swelling of fuels disposed within the cladding tubes. The interaction between the fission gases produced by the fuel and the fuel itself and the cladding results in nucleation and propagation of cracks and depressurization of the fuel cladding tube. For example, a significant in-reactor life-limiting use with currently available fuel cladding tubes is corrosion, especially in the presence of water and increased operating temperatures of newer generations of nuclear reactors, such as light water reactors (LWRs) and supercritical water-cooled reactors (SCWRs).

Corrosion of the cladding may be caused by the fission gases present in the gap between the fuel in the cladding tube and the cladding and the interaction between the fuel and the cladding tube as the fuel expands due to thermal expansion of the fuel. The resulting accumulation of fission gases in the fuel-clad gap results in lowering of the thermal conductance of the gap between the fuel and the cladding, as gas having relatively high thermal conductivity, typically helium, that is present in the gap between the cladding and the fuel is replaced with fission gases produced by the fuel having relatively lower thermal conductivity. Lower gap thermal conductivity between the fuel and the cladding may reduce the life of the fuel rod by increasing the centerline temperature of the fuel, for example, by increasing the thermal expansion of the fuel thereby leading to greater deformation and corrosion of the cladding.

Furthermore, the chemical state and concentration of the fission products (i.e., single atoms, oxides, and/or other complex compounds) may influence chemical reactions between the fuel and the cladding. These chemical reactions, when they occur, result in corrosion of the metal cladding and a consequent weakening of the cladding, which is the primary barrier that prevents the radioactive gases release. For example, buildup of oxide material on the fuel cladding tubes formed with zirconium caused by oxidation of zirconium during reactor operation may lead to adverse effects on thermal conduction. Hydrogen generated by oxidation of the zirconium in the fuel cladding tubes causes embrittlement of the zirconium and formation of precipitates in the fuel cladding tube, which is under an internal gas pressure. The presence of the precipitates may reduce mechanical strength of the fuel cladding tube causing cracks in walls and end caps. Such cracks propagate from an internal surface of the fuel cladding tube to an external surface and, thus, may rupture the cladding wall. Depressurization of the fuel cladding tube due to stress corrosion cracking significantly reduces the life of the fuel cladding tube and, in addition, reduces the output and safety of the nuclear reactor. Moreover, the fuel cladding tube may be circumferentially loaded in tension due to expansion of the contents, such as fuel pellets, within the fuel cladding tube. Deformation of the fuel cladding tube resulting from such tension increases susceptibility of the fuel cladding tube to stress corrosion failure.

### BRIEF SUMMARY

In some embodiments, the present disclosure includes a fuel element for use in a reactor including a fuel and a cladding tube having a longitudinal axis where the fuel is disposed within the cladding tube. At least one channel is formed in at least one of the fuel and the cladding tube and extends in a direction of the longitudinal axis of the cladding tube. The fuel element further includes a plenum having at least one getter material disposed therein.

In additional embodiments, the present disclosure includes a method of segregating gases in a fuel element including forming a temperature differential between an outer surface of a fuel and an inner surface of a cladding tube in which the fuel is disposed, enabling at least one gas to travel radially away from the fuel and into at least one channel formed in at least one of the fuel and the cladding tube, and chemically retaining a portion of the at least one gas with at least one getter material.

In yet additional embodiments, the present disclosure includes a method of segregating gases in a fuel element including enabling at least one gas to travel through at least one channel of a plurality of channels in at least one of a fuel and a cladding tube in which the fuel is disposed to a plenum positioned at a lower end of the fuel, and retaining the at least one gas in the plenum with at least one getter material disposed in the plenum.

### BRIEF DESCRIPTION OF THE SEVERAL VIEWS OF THE DRAWINGS

While the specification concludes with claims particularly pointing out and distinctly claiming that which is regarded as the embodiments of the present disclosure, the advantages of the embodiments of the present disclosure may be more readily ascertained from the following description of the embodiments of the present disclosure when read in conjunction with the accompanying drawings in which:

FIG. 1 is a cross-sectional side view illustrating an embodiment of a fuel element in accordance with the present disclosure;

FIG. 2 is a cross-sectional top view illustrating a fuel element such as the fuel element shown in FIG. 1;

FIG. 3 is a cross-sectional top view illustrating another embodiment of a fuel element in accordance with the present disclosure; and

FIG. 4 is a cross-sectional top view illustrating yet another embodiment of a fuel element in accordance with the present disclosure.

### DETAILED DESCRIPTION

In the following detailed description, reference is made to the accompanying drawings that depict, by way of illustration, specific embodiments in which the disclosure may be practiced. However, other embodiments may be utilized, and structural, logical, and configurational changes may be made without departing from the scope of the disclosure. The illustrations presented herein are not meant to be actual views of any particular fuel element or component thereof, but are merely idealized representations that are employed to describe embodiments of the present disclosure. The drawings presented herein are not necessarily drawn to scale. Additionally, elements common between drawings may retain the same numerical designation.

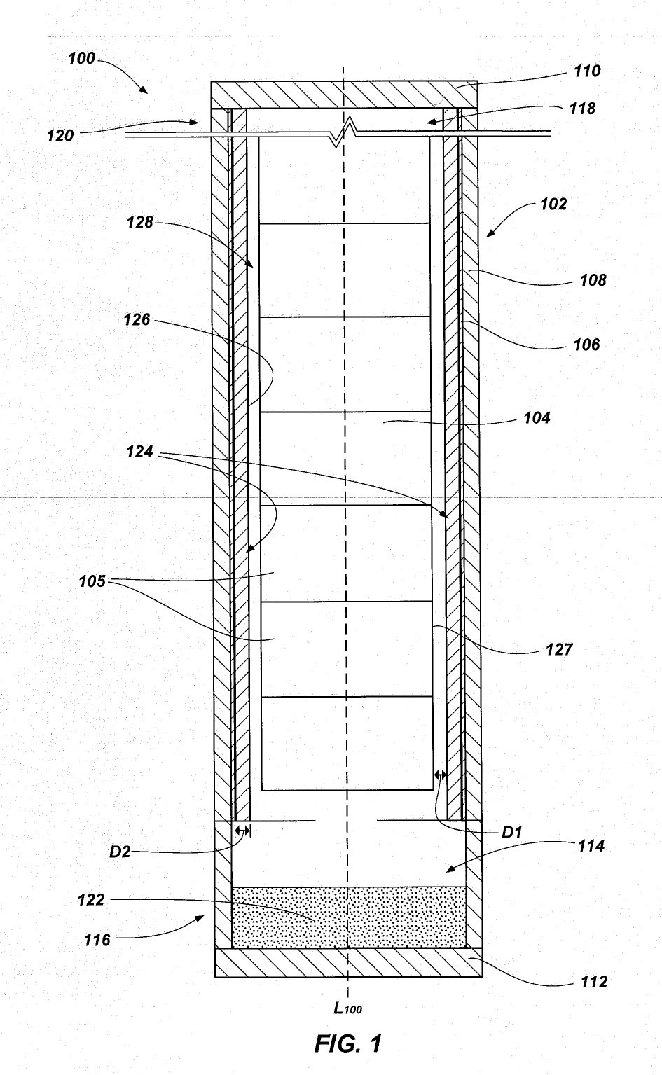

FIG. 1 is a cross-sectional side view illustrating an embodiment of a fuel element according to the present disclosure. As shown in FIG. 1, a fuel element 100 (e.g., a fuel rod) may include cladding (e.g., a cladding tube 102) and fuel 104 (e.g., nuclear fuel such as metal fuels (e.g., actinide), oxide fuels, ceramic fuels, etc.) housed within the cladding tube 102. The fuel element 100 may be used in a reactor such as, for example, in a nuclear power plant or other power plant. In such embodiments, the tube 102 may be used as a containment tube for one or more fuels in the reactor. For example, the cladding tube 102 may be used to contain nuclear fuel 104 in a variety of nuclear reactor designs, such as, light water reactors (LWR), pressurized water reactors (PWR), liquid metal fast reactors (LMFR), high temperature gas-cooled reactors (HTGR), and steam cooled reactor boiling-water reactors (SCBWR). It is noted that while the embodiment of FIG. 1 illustrates the cladding tube 102 as having an elongated cylinder shape surrounding a hollow compartment, in other embodiments, the cladding tube 102 may be formed in any number of cross-sectional shapes (e.g., other circular or oval shapes, triangular shapes, quadrilateral shapes, polygonal shapes, etc.). In some embodiments, the nuclear fuel 104 may be formed by a plurality of fuel pellets 105. In other embodiments, the nuclear fuel may be formed as a unitary rod (e.g., a rod having channels formed therein, as discussed below with reference to FIG. 3).

In some embodiments, the cladding tube 102 may be formed from a metallic material. For example, the cladding tube 102 may be formed from a monolithic metallic material that comprises one single, unbroken unit without joints or seams and may be fanned from a ductile metal or metal alloy. In some embodiments, the metallic material may be formed from at least one of zirconium, iron, nickel, chromium, molybdenum, niobium, bismuth, and alloys thereof. For example, the metallic material may be formed from a zirconium alloy, such as zircaloy-2, zircaloy-4, and other low tin zirconium-tin alloys.

In some embodiments, the cladding tube 102 may include an inner cladding 106 and an outer cladding 108. For example, the inner cladding 106 may be formed from a metallic material (e.g., as discussed above) and the outer cladding 108 may be formed from a ceramic matrix composite. The ceramic matrix composite may comprise a ceramic matrix interspersed with reinforcing fibers. For example, such cladding materials that may be used in the cladding tube 102 or portions thereof are described in U.S. patent application Ser. No. 12/901,309, titled “Methods of Producing Silicon Carbide Fibers, Silicon Carbide Fibers, and Articles Including Same,” filed on Oct. 8, 2010 and U.S. patent application Ser. No. 12/901,326, titled “Cladding Material, Tube Including Such Cladding Material and Methods of Forming the Same,” filed on Oct. 8, 2010, the disclosure of each of which is incorporated herein in its entirety by this reference.

The fuel element 100 may include end caps 110, 112 that are welded or otherwise secured to longitudinal ends of the cladding tube 102. The end caps 110, 112 may include any metal, metal alloy, or other material suitable and may act to contain the fuel 104 and starting gas disposed within the fuel element 100 along with fission gases generated during fuel operation. For example, the cladding tube 102 may contain starting gas disposed within the fuel element 100 prior to operation of the fuel element 100 (e.g., in a reactor) having a relatively high thermal conductivity such as, for example, pressurized helium. The end caps 110, 112 may enable hermetic sealing of the cladding tube 102 containing the fuel 104 and the pressurized starting gas along with any fission gas products formed during the use life of the fuel life.

The fuel element 100 may include one or more volumes (e.g., one or more plenums) formed therein to enable the fuel element 100 to accommodate excess starting gases and fission gases generated during fuel operation. For example, a plenum 114 may be formed at a lower end 116 of the fuel element 100 between the fuel 104 and the lower end cap 112. It is noted that the terms “lower,” “upper,” and “below” as used herein refer to the portions of the fuel element 100 as oriented in FIG. 1 that depicts the orientation of the fuel element 100 as it would be positioned in a reactor. In some embodiments, the fuel element 100 may include a plenum 118 formed at an upper end 120 of the fuel element 100 between the fuel 104 and the upper end cap 110.

The fuel element 100 may include a getter material disposed therein to collect (e.g., by adsorption, absorption, etc.) a portion of the gases (e.g., fission gases). For example, one or more getter materials 122 may be disposed in the plenum 114 at the lower end 116 of the fuel element 100. It is noted that the configuration of the getter materials 122 in the plenum 114 is shown in the embodiment of FIG. 1 for simplicity; however, the getter materials 122, in the plenum 114 or otherwise, may be disposed within the fuel element 100 in any suitable configuration to enable the collection of gases.

In some embodiments, the getter materials 122 may include one or more of activated carbon, zeolite materials, aluminium oxide (e.g., transition alumina), carbon nanostructures, amorphous graphite, silicon (e.g., amorphous silica), zirconium, molybdenum, titanium, tantalum, hafnium, niobium, thorium, uranium, yttrium, tungsten, zirconium silicate, titanium silicate, and alloys, mixtures thereof, or in combination with another material (e.g., aluminum). In some embodiments, the getter materials 122 may be selected to retain one or more fission gases (e.g., xenon, krypton, cesium, iodine, etc.) generated during operation of the fuel element 100. For example, the getter materials 122 may be selected to retain gas having a relatively higher molecular weight than the molecular weight of the starter gas (e.g., helium). By way of further example, the getter materials 122 may be selected to retain gas exhibiting a relatively lower thermal conductivity than the thermal conductivity of the starter gas. In some embodiments, the getter materials 122 may be selected to retain one or more specific fission gases generated during operation of the fuel element 100. For example, the getter materials 122 may include materials such as zeolite materials (e.g., doped zeolite materials) and silver nitrate (AgNO₃) configured to capture specific fission gases such as iodine and cesium.

It is noted that while the embodiment of FIG. 1 illustrates the getter materials 122 as being disposed in the plenum 114 at the lower end 116 of the fuel element 100, in other embodiments, getter materials 122 may be positioned in any other suitable location or locations in the fuel element 100. For example, getter materials 122 may be disposed in a volume (e.g., a plenum) formed between fuel pellets 105 of the fuel 104 in the fuel element 100. By way of further example, the getter materials may be disposed in a volume formed between the fuel 104 and other portions of the fuel element 100 (e.g., the cladding tube 102, the end cap 110, etc.). It is further noted that while the plenum 114 is shown as being partially sectioned off from the fuel 104, in other embodiments, the plenum may be entirely open to and in communication with the inner portion of the cladding tube 102 holding the fuel 104.

In some embodiments, one or more getter materials may be formed as part of the fuel 104 (e.g., in one or more of the fuel pellets 105). For example, the fuel may include a fuel having a getter material integrally formed therein, such as the fuel described in U.S. patent application Ser. No. 13/178,854 to Gamier et al., entitled “Composite Materials, Bodies and Nuclear Fuels Including Metal Oxide and Silicon Carbide and Methods of Forming Same,” and filed on even date herewith, the disclosure of which is incorporated herein in its entirety by this reference.

Referring still to FIG. 1, the fuel element 100 may include a gap between the fuel 104 and the cladding tube 102 (i.e., a fuel-clad gap 128). The fuel-clad gap 128 may be provided to enable loading of the fuel 104 into the cladding tube 102 and enable a starting gas to be disposed in the fuel element 100. For example, as shown in FIG. 1, the fuel-clad gap 128 may extend around the fuel 104 disposed within the cladding tube 102 forming a space between the fuel 104 (e.g., an outer surface 127 of the fuel 104) and the cladding tube 102 (e.g., an inner surface 126 of the cladding tube 102) having a distance D1 between a portion of the fuel 104 and a portion of the cladding tube 102. In other embodiments, the fuel element may be sized to provide little or no gap between the cladding tube and the fuel such that portions of the fuel are in contact with an inner surface of the cladding tube prior to use of the fuel element.

The fuel element 100 may include one or more channels formed in the cladding tube 102. For example, a portion of the cladding tube 102 (e.g., the inner cladding 106, where implemented) may include one or more channels 124 extending in a direction along a longitudinal axis L₁₀₀ of the fuel element 100. For example, the channels 124 formed in the cladding tube 102 may extend along the fuel 104 to a location proximate to the plenum 114. It is noted that while the embodiment of FIG. 1 illustrates the channels 124 extending to the plenum 114, in other embodiments, such as those described above having getter materials formed integrally with the fuel or between portions of the fuel, the channels 124 may extend only partially along portions of the fuel 104 to the location of the getter material. It is further noted, that while the channels 124 are shown in FIG. 1 as extending in a straight line along the length of the cladding tube 102, in other embodiments, the channels may extend along the fuel element (or be formed in the fuel, as discussed above) in other suitable configurations. For example, the channels may extend along the fuel element in a spiral or in a helical configuration.

The channels 124 may form passageways enabling gases (e.g., fission gases and starting gases) to travel along the fuel element 100 (e.g., in a direction along the longitudinal axis L₁₀₀). For example, as shown in FIG. 1, the channels 124 may form passageways positioned around the fuel 104 forming a space between the outer surface 127 of the fuel 104 and an inner surface 126 of the cladding tube 102 forming the channels 124 exhibiting a distance D2. Stated in another way, the channels 124 may be formed in the cladding tube 102 to have a depth (i.e., a dimension extending along a lateral axis of the fuel element 100) of the distance D2. In some embodiments, the channels 124 may extend into the cladding tube 102 the distance D2 of between 0.025 millimeter to 2.5 millimeters.

When implemented in a reactor, the fuel 104 of the fuel element 100 may swell due to thermal expansion of the fuel 104 causing reduction of the fuel-clad gap 128. The channels 124 may enable gases to still travel along the fuel element 100 even after the size of fuel-clad gap 128 has been reduced or substantially blocked. For example, when portions of the fuel 104 have swollen an amount to be in contact with the inner surface 126 of the cladding tube 102 and have substantially closed the fuel-clad gap 128, gases may still pass through the channels 124.

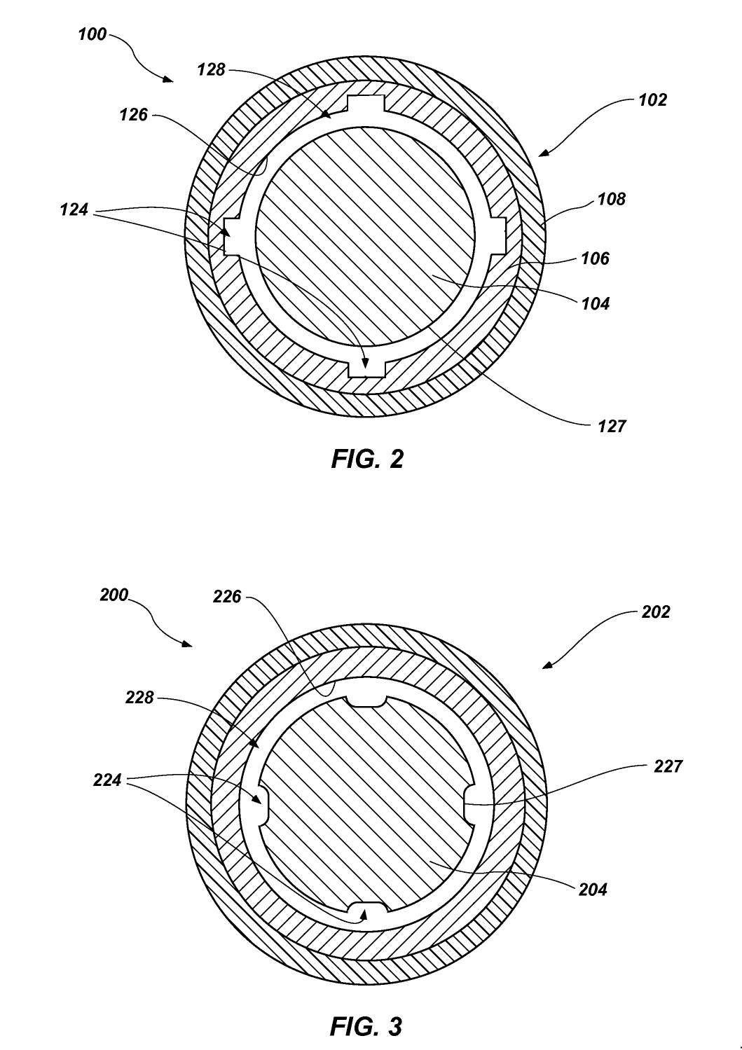

FIG. 2 is a cross-sectional top view illustrating a fuel element such as the fuel element shown in FIG. 1. As shown in FIG. 2, the fuel element 100 may include the cladding tube 102 having the fuel 104 disposed therein. The channels 124 may be formed in the cladding tube 102 (e.g., in the inner cladding 106 of the cladding tube 102). The channels 124 may provide passageways in the fuel element 100 (e.g., in addition to the fuel-clad gap 128) extending between the inner surface 126 of the cladding tube 102 and the outer surface 127 of the fuel 104 that enable gases to travel along the length of the fuel element 100.

FIG. 3 is a cross-sectional top view illustrating another embodiment of a fuel element. As shown in FIG. 3, the fuel element 200 may be somewhat similar to the fuel element 100, shown and described with reference to FIGS. 1 and 2, and may include a cladding tube 202 having fuel 204 disposed therein. The fuel element 200 may include channels 224 formed in the fuel 204. The channels 224 may provide passageways in the fuel element 200 (e.g., in addition to the fuel-clad gap 228) extending between an inner surface 226 of the cladding tube 202 and an outer surface 227 of the fuel 204 that enable gases to travel along the length of the fuel element 200. In some embodiments, the channels 224 in the fuel 204 may be formed in one unitary rod of fuel 104. In other embodiments, the channels 224 may be formed in individual fuel pellets such as the fuel pellets 105, shown and described above in FIG. 1 and aligned when the fuel pellets having the channels formed therein are disposed in the cladding tube 204.

It is noted that while the embodiments of FIGS. 1 through 3 illustrate channels formed in either the fuel or cladding tube, in other embodiments, a fuel element may include one or more channels formed in a combination of the cladding tube and the fuel.

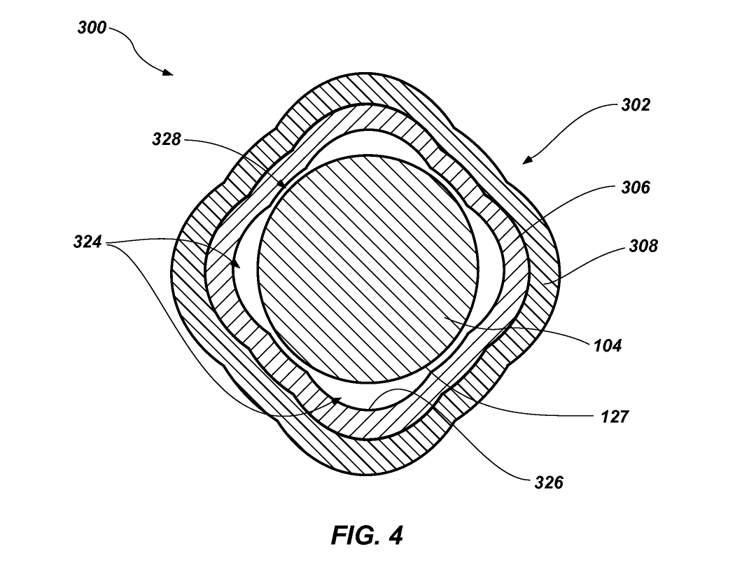

FIG. 4 is a cross-sectional top view illustrating yet another embodiment of a fuel element. As shown in FIG. 4, the fuel element 300 may be somewhat similar to the fuel elements 100, 200, shown and described with reference to FIGS. 1 through 3 and may include a cladding tube 302 having fuel 104 disposed therein. The fuel element 300 may include channels 324 formed in the cladding tube 302 (e.g., in an inner cladding 306 of the cladding tube 302) extending between an inner surface 326 of the cladding tube 302 and the outer surface 127 of the fuel 104. The channels 324 may be formed in the cladding tube 302 such that a wall thickness of the cladding tube 302 is substantially constant around the fuel 104. In other words, a lateral cross section of the cladding tube 302 may have a substantially constant wall thickness (i.e., a lateral thickness) about the fuel 104. For example, a wall of the cladding tube 302 proximate to the channels 324 (i.e., the portion of the cladding tube 302 forming a portion of the channels 324) may exhibit a thickness substantially similar to the thickness of the wall of the cladding tube 302 adjacent to the channels 324.

The channels 324 may provide passageways in the fuel element 300 (e.g., in addition to the fuel-clad gap 328) enabling gases to travel along the length of the fuel element 300. In some embodiments, the cladding tube 302 having a substantially constant wall thickness may be formed to have an inner cladding 306 and outer cladding 308. For example, the cladding tube 302 may be formed to include an inner metallic material surrounded by fiber-reinforced ceramic matrix composite (e.g., reinforcing fibers within a silicon carbide matrix, reinforcing fibers within a boron carbide matrix, etc.). As identified above, such cladding tubes formed from an inner metallic material surrounded by a fiber-reinforced ceramic matrix composite are disclosed in, for example, in the above-mentioned U.S. patent application Ser. No. 12/901,309.

In operation, a fuel element (e.g., fuel elements 100, 200, 300, as shown and described with reference to FIGS. 1 through 4) enables separation of gases in the fuel element. Such separation of gases may act to increase the thermal conductivity in the fuel element over the life of the fuel element by reducing the amount of relatively heavy molecular weight fission gases located proximate to the fuel in the fuel element while retaining the original high thermal conductivity starter gas in proximity to the fuel. For example, when implemented in a reactor, the channels (e.g., channels 124, 224, 324, as shown and described with reference to FIGS. 1 through 4) enable fission gases (e.g., xenon, krypton, cesium, iodine, etc.) to be at least partially separated and removed from the starting gas (e.g., helium). During operation of the reactor, the fuel within the fuel element will release fission gases into the fuel element. Such fission gases will reduce the thermal conductivity of the fuel element, consequently reducing the life of the fuel element (e.g., by increasing the centerline temperature of the fuel element as the lower thermal conductivity hinders the ability of the fuel in the fuel element to release heat). The channels formed in the cladding tube, the fuel, or combinations thereof provide passageways through which the gases may travel even in circumstances where the fuel in the fuel element has swelled and substantially closed the initial fuel-clad gap.

By providing passageways through the fuel element, the channels may enable what may described as a Clusius-Dickel effect to occur within the fuel element. That is, the space in the passageways provided by the channels enables the fuel element to exhibit a temperature differential enabling gases having different mass and velocities to separate. For example, the fuel element may exhibit a difference in temperature between an outer surface (e.g., outer surface 127, 227, as shown and described with reference to FIGS. 1 through 4) of the fuel and an inner surface (e.g., inner surface 126, 226, 326, as shown and described with reference to FIGS. 1 through 4) of the cladding tube. During operation of the reactor, the temperature at the outer surface of the fuel will be greater than the temperature at the inner surface of the cladding tube. Such a temperature differential may range, for example, between 10° C. to 300° C. However, as understood by those of ordinary skill in the art, the magnitude of the temperature differential between the outer surface of the fuel and the inner surface of the cladding tube may vary along the fuel element and may vary due to the operation of the reactor in which the fuel element is placed (e.g., during a power ramp). This temperature differential enables the gas mixture (e.g., the starting gas and the gases released by the fuel during operation) having components with differing molecular weights to be separated in the fuel element due to the effects of thermal diffusion and convection.

In the fuel element, a starting gas having a relatively higher thermal conductivity and a relatively lower molecular weight such as helium and fission gases having a relatively lower thermal conductivity and a relatively higher molecular weight will tend to be separated when subjected to the temperature differential between the fuel and the cladding tube. Thermal diffusion will tend to direct the relatively lighter starting gas toward the relatively hotter surface (i.e., the outer surface of the fuel). Further, convection of the gases combined with gravitational forces will tend to direct the relatively lighter starting gas upward. Conversely, the thermal diffusion will tend to direct the relatively heavier fission gases toward the relatively colder surface (i.e., the inner surface of the cladding tube). Further, convection of the gases combined with gravitational forces will tend to direct the relatively heavier fission gases downward.

Stated in another way, the separation of the gases in the fuel element may be governed by the momentum (p) of each of the gases. The momentum of each gas is equal to the mass (m) and velocity (v) (i.e., p=mv). Each of the gases at the heated wall (e.g., the outer surface 127 of the fuel 104) has the same momentum (e.g., the momentum of the starting gas is equal to the momentum of the fission gases). Therefore, if the momentums of the gases are equal, the relatively lighter starting gas will have a velocity that is greater than the relativity heavier fission gases. The relatively higher velocity starting gas will tend to remain in proximity to the fuel (e.g., in a volume between the fuel and the cladding tube), while the relatively lower velocity fission gases will tend to move downward along the cladding tube 102 toward the lower end 116 of the fuel element 100 (FIG. 1).

The heavier fission gases exhibiting a lower thermal conductivity may be contained away from the fuel by getter material disposed within the fuel element (e.g., getter materials 122 positioned in the plenum 114 at the lower end 116 of the fuel element 100, as shown and described with reference to FIG. 1). With the heavier fission gases contained away from the fuel, a greater amount (relative to other fuel elements) of the lighter starter fuel having a relatively higher thermal conductance will enable a greater life of the fuel element, for example, by enabling heat from the fuel to be more efficiently transferred, thereby, reducing the centerline temperature of the fuel.

Fuel elements in accordance with the present disclosure may be particularly useful in providing a fuel element for use in a reactor that has a substantially increased lifetime, improved safety margins, and greater operating flexibility in comparison to conventional fuel elements. Such fuel elements including passageways enabling gaseous separation in both the radial and axial direction along the fuel element and getter materials that retain fission gases away from the fuel. Such separation of gases and entrainment of fission gases in the fuel element may be utilized to reduce the amount of fission gases proximate to the fuel. The reduction in the concentration of fission gas products proximate to the fuel may result in a reduction in the internal stress corrosion of the cladding as iodine and cesium and other heavy fission gas products are removed and entrained away from the fuel. For example, the reduction in the concentration of fission gas products species will reduce the kinetics of diffusion of these species into the inner wall of the cladding of the fuel element and mitigate the onset and rate of inner tube liner stress corrosion cracking. The reduction of the heavy fission gas products also results in improved fuel-clad heat transfer by maintaining a high thermal gap conductance by enabling a greater amount of the starter gas having relatively higher thermal conductivity in the space between the fuel and the cladding tube. Moreover, a reduction in the concentration of fission gas products proximate to the fuel may also result in maintaining a higher thermal gap conductance throughout the life of the fuel element that will reduce fuel centerline temperature, especially at later burn up life.

While the present disclosure may be susceptible to various modifications and alternative forms, specific embodiments have been shown by way of example in the drawings and have been described in detail herein. However, it should be understood that the present disclosure is not intended to be limited to the particular forms disclosed. Rather, the present disclosure is to cover all modifications, equivalents, and alternatives falling within the scope of the disclosure as defined by the following appended claims and their legal equivalents.

1. A fuel element for use in a reactor, comprising:
a fuel;
a cladding tube having a longitudinal axis, the fuel being disposed within the cladding tube;
at least one channel formed in at least one of the fuel and the cladding tube, the at least one channel extending in a direction of the longitudinal axis of the cladding tube; and
a plenum having at least one getter material disposed therein.

2. The fuel element of claim 1, wherein the plenum and the at least one getter material are positioned at a lower portion of the fuel element.

3. The fuel element of claim 1, wherein the at least one channel comprises a plurality of channels formed in at least one of the fuel and the cladding tube.

4. The fuel element of claim 3, wherein each channel of the plurality of channels formed in at least one of the fuel and the cladding tube extends into the at least one of the fuel and the cladding tube a depth of at least 0.025 millimeter.

5. The fuel element of claim 3, wherein each channel of the plurality of channels formed in at least one of the fuel and the cladding tube extends into the at least one of the fuel and the cladding tube a depth of between 0.025 millimeter to 2.5 millimeters.

6. The fuel element of claim 3, wherein each channel of the plurality of channels is formed in the cladding tube and wherein a lateral wall thickness of the cladding tube extending around the fuel is substantially constant.

7. The fuel element of claim 3, wherein the cladding tube comprises an inner cladding and an outer cladding and wherein the plurality of channels is formed in the inner cladding of the cladding tube.

8. The fuel element of claim 7, wherein the inner cladding comprises a metallic material and the outer cladding comprises a fiber-reinforced ceramic matrix composite.

9. The fuel element of claim 8, wherein the inner cladding comprises zirconium and the outer cladding comprises at least one of reinforcing fibers in a silicon carbide matrix and reinforcing fibers in a boron carbide matrix.

10. The fuel element of claim 1, wherein the cladding tube is sized to provide a gap between the fuel and the cladding tube extending around an entirety of an outer circumference of the fuel.

11. The fuel element of claim 1, further comprising at least another getter material formed integrally with the fuel.

12. A method of segregating gases in a fuel element, comprising:
forming a temperature differential between an outer surface of a fuel and an inner surface of a cladding tube in which the fuel is disposed;
enabling at least one gas to travel radially away from the fuel and into at least one channel formed in at least one of the fuel and the cladding tube; and
chemically retaining a portion of the at least one gas with at least one getter material.

13. The method of claim 12, further comprising enabling the at least one gas to travel through the at least one channel formed in at least one of the fuel and the cladding tube into a plenum positioned proximate to an end of the fuel and having the at least one getter disposed therein.

14. The method of claim 12, wherein chemically retaining a portion of the at least one gas with at least one getter material comprises chemically retaining a portion of the at least one gas with at least one getter material formed integrally with the fuel.

15. The method of claim 12, wherein enabling at least one gas to travel radially away from the fuel comprises:
separating a first gas from a second gas comprising a molecular weight that is greater than a molecular weight of the first gas;
retaining the first gas proximate to the fuel; and
enabling the second gas to travel away from the fuel through the at least one channel to the at least one getter material.

16. The method of claim 12, wherein enabling at least one gas to travel radially away from the fuel comprises:
separating a first gas from a second gas comprising a thermal conductivity that is less than a thermal conductivity of the first gas;
retaining the first gas proximate to the fuel; and
enabling the second gas to travel away from the fuel through the at least one channel to the at least one getter material.

17. A method of segregating gases in a fuel element, comprising:
enabling at least one gas to travel through at least one channel of a plurality of channels in at least one of a fuel and a cladding tube in which the fuel is disposed to a plenum positioned at a lower end of the fuel; and
retaining the at least one gas in the plenum with at least one getter material disposed in the plenum.

18. The method of claim 17, further comprising:
separating a first gas from a second gas comprising a molecular weight that is greater than a molecular weight of the first gas and a thermal conductivity that is less than a thermal conductivity of the first gas; and
retaining the first gas proximate to the fuel;
wherein enabling at least one gas to travel through at least one channel of the plurality of channels comprises enabling the second gas to travel through the at least one channel of the plurality of channels.

19. The method of claim 18, wherein enabling the second gas to travel through the at least one channel of the plurality of channels comprises:
forming the at least one channel of the plurality of channels to exhibit a relatively colder portion and a relatively warmer portion; and
enabling the gas to travel from the relatively warmer portion of the at least one channel of the plurality of channels axially to the relatively colder portion of the at least one channel of the plurality of channels.

20. The method of claim 17, further comprising:
forming a plurality of channels in at least one of a fuel and a cladding tube;
forming the plurality of channels in the cladding tube; and
forming the cladding tube to exhibit a substantially constant wall thickness about a lateral cross section of the cladding tube.
